(19) United States
(12) Patent Application Publication
(10) Pub. No.: US 2021/0009362 A1
(43) Pub. Date: Jan. 14, 2021

(54) PARCEL AND PALLET SORTING SYSTEM AND METHOD

(71) Applicant: Siemens Logistics LLC, DFW Airport, TX (US)

(72) Inventors: Francisco Grupp, Trophy Club, TX (US); Michael D. Carpenter, Arlington, TX (US)

(21) Appl. No.: 16/504,381

(22) Filed: Jul. 8, 2019

(51) Int. Cl. B65G 47/48; B07C 3/18; B07C 3/08; B07C 5/36; G06Q 10/08

(52) U.S. Cl. CPC B65G 47/48; B07C 3/18; B07C 3/08; B65D 71/0096; G06Q 10/083; B65D 2203/06; B07C 5/36

(57) ABSTRACT

A parcel sorter system and method. A process performed by a parcel sorter system includes receiving sorting information of a first parcel. The process includes identifying a first destination pallet corresponding to the sorting information. The first destination pallet is associated with a first pallet carousel and a first destination chute. The process includes transporting the first parcel toward the first destination chute. The process includes, while transporting the parcel toward the first destination chute, operating the first pallet carousel to move the first destination pallet proximate to the first destination chute. The process includes delivering the first parcel at the first destination chute for placement on the first destination pallet.

### TECHNICAL FIELD

The present disclosure is directed, in general, to parcel processing techniques.

### BACKGROUND OF THE DISCLOSURE

To efficiently transport parcels, the parcels are often sorted and loaded onto pallets. Improved and more efficient systems for sorting, processing, and palletizing parcels, and for processing the parcel pallets, are desirable.

### SUMMARY OF THE DISCLOSURE

Various disclosed embodiments include a process performed by a parcel sorter system includes receiving sorting information of a first parcel. The process includes identifying a first destination pallet corresponding to the sorting information. The first destination pallet is associated with a first pallet carousel and a first destination chute. The process includes transporting the first parcel toward the first destination chute. The process includes, while transporting the parcel toward the first destination chute, operating the first pallet carousel to move the first destination pallet proximate to the first destination chute. The process includes delivering the first parcel at the first destination chute for placement on the first destination pallet.

Another disclosed embodiment includes a parcel sorter system, comprising a control system, a parcel sorter under control of the control system, a plurality of destination chutes configured to receive parcels from the parcel sorter, and a plurality of pallet carousels under control of the control system, each pallet carousel transporting a plurality of pallets. The control system is configured to perform processes as described herein.

Various embodiments include moving the first parcel from the first destination chute to the first destination pallet. In various embodiments, the parcel sorter system moves the first parcel from the first destination chute to the first destination pallet using a palletizing robot. Various embodiments include operating the first pallet carousel to move the first destination pallet into position to be removed from the first pallet carousel. Various embodiments include controlling a pallet transport and management system to remove and replace the first destination pallet. In various embodiments, the pallet transport and management system shrink-wraps the first destination pallet. In various embodiments, receiving sorting information of the first parcel includes using a reader to detect indicia on the first parcel and performing an optical character recognition process on the indicia. In various embodiments, receiving sorting information of the first parcel includes using a reader to detect indicia on the first parcel and performing a barcode recognition process on the indicia. In various embodiments, the first parcel is delivered to the first destination chute at the same time as or after the first destination pallet arrives proximate to the first destination chute. Various embodiments include determining that the first destination pallet is filled.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a sorting system;

FIG. 2 illustrates an example of a sorting system in accordance with disclosed embodiments;

FIG. 3 illustrates a flowchart of a process in accordance with disclosed embodiments; and

FIG. 4 depicts a block diagram of a data processing system in which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Postal agencies have introduced “Work Sharing” programs whereby customers introduce batches of items to be delivered deeply into the postal distribution network, meaning that these items are presented to the postal agencies at a point nearer the ultimate delivery destination of the parcels, so that the postal agency avoids some of the initial sorting and transportation of the items. By doing so, the processing costs of the postal agency can be greatly reduced, and a portion of this savings can be passed along to the originator in the form of discounts on the delivery fee. The deepest discounts are offered in cases in which the items to be delivered are injected at the final processing step, very near the destination. While this approach has been common for many years in the processing and delivery of mail such as letters or flats (magazine-sized items), only recently has this approach become a major factor in the delivery of goods (parcels) by postal agencies.

To realize savings, items meeting a threshold of quantity as well as meeting the preparation and processing standards of the Postal Agency are delivered to post offices that serve local communities. From the standpoint of processing and preparation, a sorting operation is relatively unusual in that a relatively high number of sorting breaks that are required, which exceeds the largest configurations of parcel sorter. Indeed, operations of this type typically employ a hierarchical sorting process, in which the initial sort is often automated, and the sorted output of the initial automated sorting process are sorted again manually. The hierarchical structure of sorting elements is analogous to particular fields in the postal codes associated with the delivery addresses of the parcels. For example, sorting first to a region (the most significant digits of a postal code), and then among the neighborhoods within that region (less significant digits).

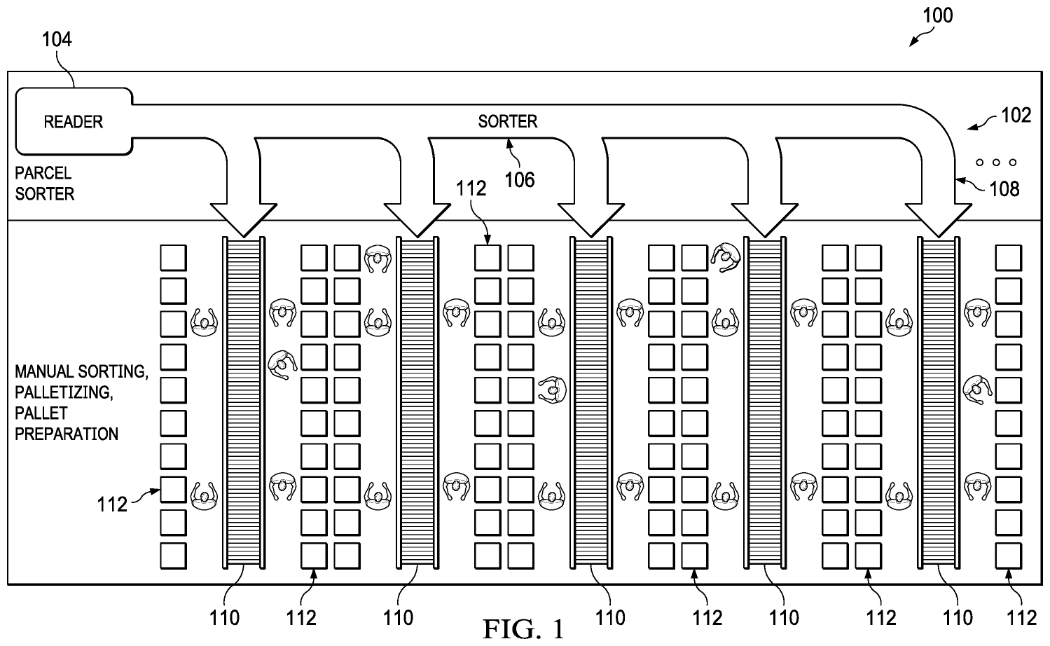

FIG. 1 illustrates one method of conducting this process in a sorting system 100. In this example, sorting system 100 includes a parcel sorter 102 which itself includes a parcel reader 104, sorter mechanism 106, and chutes 108. In such a system, long gravity conveyors 110 receive sorted parcels off of each chute 108 in the first (often automatic) sorting process. Labelled pallets 112 are juxtaposed along each gravity conveyor 110, and a human operator removes the parcel from the gravity conveyor 110 in the vicinity of the pallet 112 to which it is destined, and places it on the pallet 112. In this approach, the operator spends a great deal of time walking from pallet to pallet, which effectively establishes a relatively low sorting productivity.

In such a process, when individual pallets reach their capacity, they must be shrink-wrapped, labeled, removed, and replaced with an empty pallet. Like manual sorting, these activities involve a significant amount of walking from place to place, which translates into low productivity.

The output of this two-step sorting for standard-sized parcels is typically pallets of parcels destined to the same area. When the manual second-step of the sorting process has created a full pallet, the pallet is shrink-wrapped, labelled in accordance with postal agency requirements, and transported to the designated postal facility, to be injected into the postal agency process at a point commensurate with the degree of preparation and sortation. Since most of the processing is done manually, significant cost is involved in the operation.

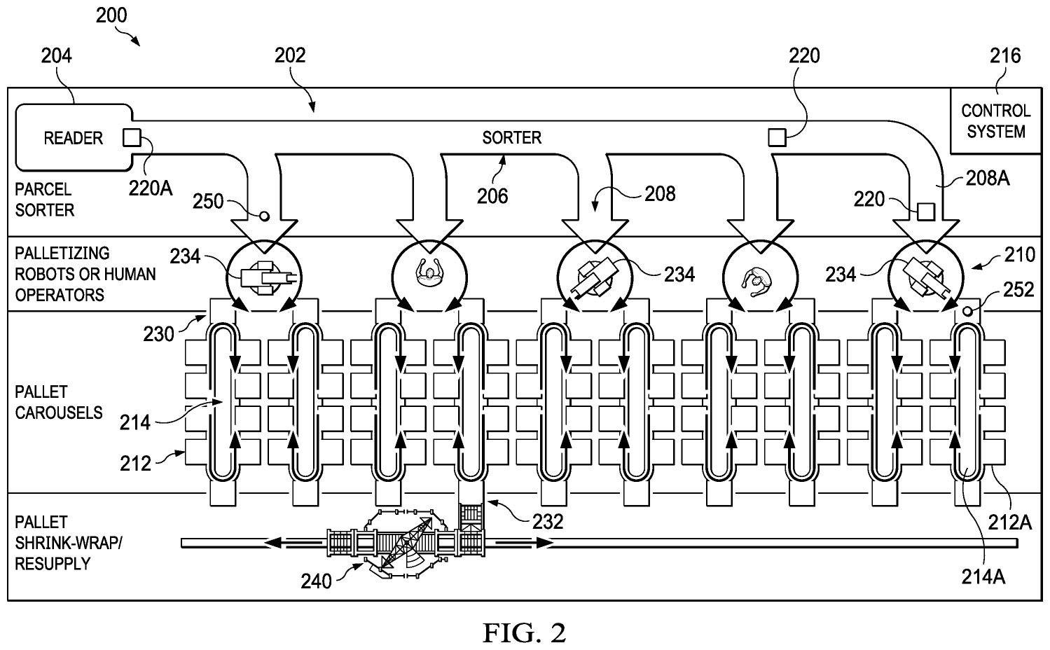

FIG. 2 illustrates an example of a sorting system 200 in accordance with disclosed embodiments, which improves on a system as illustrated in FIG. 1. A sorting system 200 as disclosed herein radically improves the productivity of the second step in sorting and in the preparation of pallets for shipment. Sorting system 200 and its various elements described herein operated under the control of a control system 216, which can be a standalone control system, a control system that also controls other devices or systems, a combination of interconnected control systems that are integrated with one or more of the components described here, or otherwise. Control system 216 is configured to control the various elements of sorting system 200 to perform actions as described herein.

In the example of FIG. 2, the sorting system 200 includes a parcel sorter 202 which itself includes a parcel reader 204, sorter mechanism 206, and destination chutes 208 (which may also be referred to herein as destination “buckets”). Parcel reader 204 determines the destination of parcels 220 on sorter mechanism 206. In the example of FIG. 5, five chutes 208 are shown on the parcel sorter 202, for simplicity of illustration, though an actual implementation may have more or even many more chutes 208. Proximate to the output of each chute 208 is one or more parcel carousels 214, each carrying a plurality of pallets 212. In this non-limiting example, there are two carousels 214 proximate to the output of each chute 208, and there are ten pallets carried by each carousel 214. At 210, human operators, palletizing robots 234, or another transport mechanism transport individual parcels 220 from each destination chute 208 onto a specific pallet 212 on a pallet carousel 214.

The sorting-destination result from the reader 204 for each parcel 220 is known well before the parcel 220 reaches its destination chute 208 on the sorter mechanism 207. In the hierarchy of sorting illustrated in FIG. 2, the ultimate number of sorting destinations is represented by the number of pallets 212 in all of the pallet carousels 214. In this example, each pallet carousel 214 holds ten pallets 212, each representing a sorting destination. There are ten carousels 214, therefore the total number of buckets (sorting destinations) is 100.

In this example, each pallet carousel 214 includes at least two access portals. A parcel access portal 230 is configured so that parcels 220 may be placed (or removed) onto individual pallets 212 on the pallet carousel 214, whether by an operator or by automation by the sorting system 200 itself using a robot, conveyor system, or otherwise. A pallet access portal 232 is configured so that individual pallets 212 can be inserted and extracted from the pallet carousel 214. In the example of FIG. 2, parcel access portal 230 is located at the end of each pallet carousel 214 nearest to the respective destination chute 208, while pallet access portal 232 is located at the end of each pallet carousel 214 furthest from the respective destination chute 208.

In various embodiments, a pallet transport and management system 240 is configured to travel between the multiple pallet access portals 232, and is configured to manage the pallets 212, performing such tasks as removing filled pallets 212 from the pallet carousel 214, shrink-wrapping or otherwise preparing filled pallets 212 for transport, transporting filled pallets 212 to further processing stages, transporting empty pallets 212 to the pallet carousels 214, and placing empty pallets 212 into the pallet carousel 214.

The capacity of each pallet carousel 214 depends on the individual design. Indeed, since the maximum carousel index time is ideally less than the latency time between the reader 204 and the destination chute 208, it may advantageous to implement shorter carousels or carousels with fewer sorting destinations at the chutes 208 nearer to the reader 204. As shown above, carousels are bidirectional; the direction providing shortest index time between the current position and the next position is preferably selected.

For each of the parcels that have passed the reader 204 (apart from unreadable parcels), the particular pallet sorting destination is determined and known by the control system 216 so that actions can be taken across the entire sorting system 200. This allows the allows the control system 216 to begin moving (“indexing”) the pallet carousels 214 containing the destination pallet 212 for each parcel 220 to the correct position prior to the parcel being sorted. This feature increases the sorting productivity, particularly but not limited to when human operators are used by reducing or eliminating any “waiting time” between when a sorted parcel is delivered from chute 208 and when the sorting destination pallet 212 is moved to the parcel access portal 230 (or otherwise in position to receive the parcel 220). Since the distance from the reader 204 to the destination chute 208 translates to the amount of carousel indexing head-start, the density destinations may be shifted to the longer-distance chutes. In some cases, the system can assign a destination layout so that the shortest distance between the reader and any chute provides adequate latency for the longest carousel indexing time.

In different embodiments, depending on various factors, including the physical characteristics of the parcels being processed, it may be advantageous to utilize either robots or human operators to perform the sorting and palletizing function, as illustrated at 210. In the illustration above, the operator or robot is responsible for placing sorted items onto one of two pallets, depending on various factors of performance and layout, this relationship could be one to four, one to six, or more. Further, as illustrated, any particular position for given parcel carousels can be assigned to a human operator, palletizing robot 234, or another transport mechanism, and so there may be a combination of these in any particular implementation.

Various embodiments can include specific design elements that reduce or prevent mis-sorting. For example, each chute 208 can be implemented with a “chevron” orientation of rollers on a gravity conveyor maintain the sequence of the items sorted to that chute and a single-file sequence of items.

In operations in which the delivery sequence from each chute 208 is not assured, the control system 216 can re-identify each item prior to sorting and palletizing. In such cases, for example, each chute 208 can include a ring scanner.

In various embodiments, a machine vision system on each chute 208 can be used to maintain the association of destination information read at the reader 204 with individual parcels 220 being sorted and palletized by either human operators or robots.

Each pallet carousel 214 can include an indicator under the control of the control system 216. The control system 216 can illuminate the indicator to signal to the operator which pallet carousel should receive the current parcel 220, as identified by sequence, reidentification, or machine vision.

When a pallet is full, the carousel 214 indexes the filled pallet 212 to the pallet access portals 232 for that carousel 214, at which that pallet can be extracted. Pallet transport and management system 240 can load the pallet extracted from the carousel, replace an empty pallet, shrink-wrap the pallet, label the pallet, and perform other functions. Pallet transport and management system 240 can include one or more mobile transporters, whether as free-moving robots or track-mounted devices, that transport and process the pallets as described herein.

In particular, a control system 216 of sorting system 200 can control the pallet carousels 214 so that the that begin indexing as soon as the parcels have been identified and assigned to a destination pallet 212, prior to parcels arriving at the chute 508, which significantly increases productivity. Further, productivity is also improved by automated shrink-wrapping and pallet handling performed by pallet transport and management system 240.

Some embodiments can include one or more sensors that enable control system 216 to determine that a parcel 220 has been moved from chute 208 to its destination pallet 212. When the control system 216 determines that a parcel 220 has been successfully moved from chute 208 to its destination pallet 212, it knows that it can begin indexing the next destination pallet 212 on that pallet carousel 214 for the next package being sorted to that carousel. That is, until a particular parcel 220 has been moved from chute 208 to its destination pallet 212, the pallet carousel 214 associated with that destination pallet 212 should not be operated to move the destination pallet 212 away from parcel access portal 230 (or otherwise in position to receive the parcel 220).

Various embodiments can include, for example, a sensor 250 on one or more of the chutes 208 that detects the presence of a parcel 220. Using sensor 250, the control system 216 can determine when a parcel 220 arrives at that chute 208 and when that parcel 220 is removed from that chute 208. Control system 216 can use this information to determine that parcels 220 are being properly transported and delivered and to determine when a parcel carousel should or should not be moved.

Alternately or additionally, various embodiments can include, for example, a sensor 252 on one or more of the destination pallet 212 or on the pallet carousel 214 at locations corresponding to destination pallets 212 that detects the presence of a parcel 220. Using sensor 250, the control system 216 can determine when a parcel 220 has been properly placed on a destination pallet 212. Control system 216 can use this information to determine that parcels 220 are being properly transported and delivered and to determine when a parcel carousel should or should not be moved.

Sensors 250 and 252 can be implemented using any appropriate sensors, such as a physical switch, a vision sensor, a weight sensor, a photosensor, or otherwise.

Depending on the distribution of the parcels 220 being sorted, the throughput of the sorter system 200, and the speed with which pallet carousels 214 are indexed/operated, the parcel sorter 220 may exceed the palletizing rate at individual positions or output chutes 208. This can be addressed in various ways in specific implementations. For example, various implementations can increase the ratio of pallet carousels 214 per chute 208.

Some implementations can provide an accumulation at each chute 208, preferably maintaining the sequence of parcels 220, and require scanning each parcel 220 prior to palletizing. An indicator or display can be used to indicate the correct pallet carousel, based on the scanning result, in implementations that use human operators to move parcels 220 from the chutes 208 to the destination pallets 212.

Various implementations can increase the number of chutes 208 per pallet carousel 214, so that the sequence of parcels 220 to optimize the prepositioning of the pallet carousel 214 is always maintained. For example, instead of one chute 208 per two pallet carousels 214, an implementation may use six chutes 208 for two pallet carousels 214. Such an implementation can use indicators or displays to communicate which pallet carousel 214 is the destination for the current parcel 220 in a given chute 208. Control system 214 can then use these features to automatically optimize the indicated chute 208 among the six according to highest pre-indexing rate.

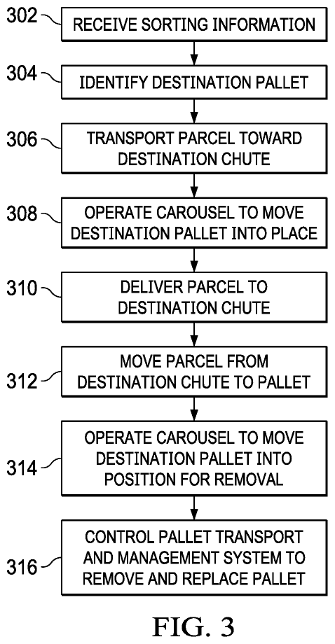

FIG. 3 illustrates a flowchart of a process in accordance with disclosed embodiments. The process of FIG. 5 can be implemented by using any of the features, components, or devices discussed herein, or any combination of them. The process of FIG. 5 is performed, for example, by a parcel sorter system as disclosed herein, and under the control of its control system.

The parcel sorter system receives sorting information for a first parcel (302). The sorting information can be, for example, a delivery destination for the first parcel, whether the ultimate delivery destination or an interim destination such as a local or regional postal office. “Receiving” data, as used herein, can include loading from storage, receiving from another device or process, or otherwise. In specific embodiments, however, the parcel sorter system receives the sorting information by using a reader 204 to detect indicia on the first parcel, such as parcel 220A, and can include performing an optical character recognition process on the indicia, performing a barcode recognition process on the indicia, and otherwise. As part of this step, the reader 204 or parcel sorter system 200 can also determine physical characteristics of the first parcel 220A, such as dimensions and weight.

The parcel sorter system identifies a first destination pallet corresponding to the sorting information (304). The first destination pallet is associated with a first pallet carousel and a first destination chute. In this example, consider that the parcel sorter system identifies destination pallet 212A as corresponding to the sorting information for parcel 220A. Destination pallet 212A is associated with pallet carousel 214A (on which it is placed/transported) and destination chute 208A (which is proximate to pallet carousel 214A).

The parcel sorter system transports the first parcel toward the first destination chute (306).

While the parcel sorter system is transporting the parcel toward the first destination chute, the parcel sorter system operates the first pallet carousel to move the first destination pallet proximate to the first destination chute (308). As described herein, this can be operating the first pallet carousel to move the first destination pallet to the parcel access portal 230 of pallet carousel 214A.

The parcel sorter system delivers the first parcel at the first destination chute for placement on the first pallet (310). The first parcel should preferably be delivered to the first destination chute at the same time as or after the first destination pallet arrives proximate to the first destination chute (or at the parcel access portal 230) so that there is no delay of being able to move the first parcel from the first destination chute to the first pallet.

In some embodiments, the parcel sorter system moves the first parcel from the first destination chute to the first pallet (312), such as by using a palletizing robot, conveyor, or other mechanical means. In other cases, a human operator can move the first parcel from the first destination chute to the first pallet.

The parcel sorter system can operate the first pallet carousel to move the first destination pallet into position to be removed from the first pallet carousel (314). This process can include determining that the first pallet is filled. This process can include operating the first pallet carousel to move the first destination pallet to a pallet access portal 232 of the first pallet carousel.

The parcel sorter system can control a pallet transport and management system to remove and replace the first pallet (316). This can include removing the first pallet from the first pallet carousel. This can include placing an empty pallet on the first pallet carousel in place of the removed first pallet. This can include shrink-wrapping or otherwise packaging the first pallet for transport. This can include transporting the first pallet away from the first pallet carousel for further processing.

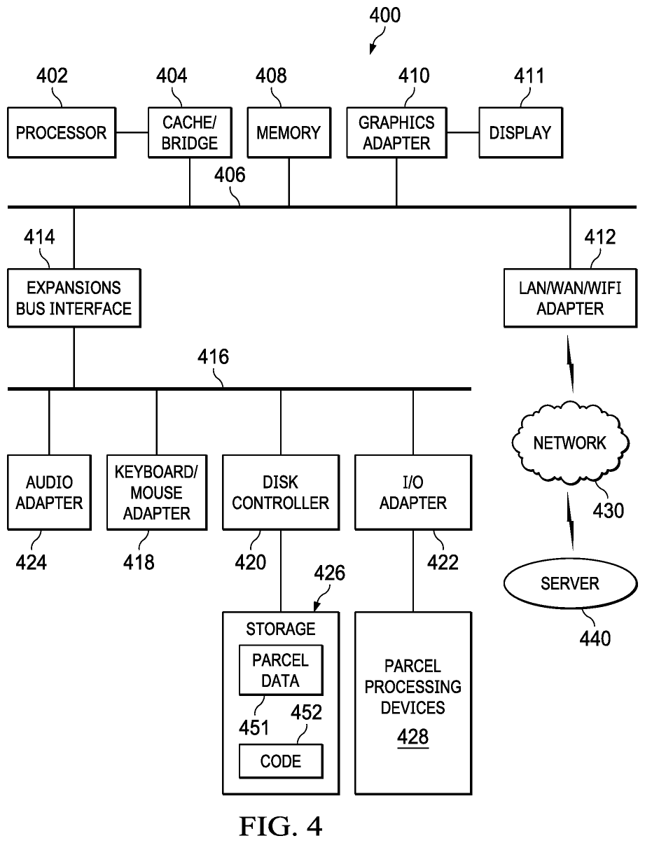

FIG. 4 depicts a block diagram of a data processing system 400 in which an embodiment can be implemented, for example as a control system for parcel sorter system as described herein and can be configured to perform processes as described herein, such as in control system 216. The data processing system depicted includes a processor 402 connected to a level two cache/bridge 404, which is connected in turn to a local system bus 406. Local system bus 406 may be, for example, a peripheral component interconnect (PCI) architecture bus. Also connected to local system bus in the depicted example are a main memory 408 and a graphics adapter 410. The graphics adapter 410 may be connected to display 411.

Other peripherals, such as local area network (LAN)/Wide Area Network/Wireless (e.g. WiFi) adapter 412, may also be connected to local system bus 406. Expansion bus interface 414 connects local system bus 406 to input/output (I/O) bus 416. I/O bus 416 is connected to keyboard/mouse adapter 418, disk controller 420, and I/O adapter 422. Disk controller 420 can be connected to a storage 426, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Storage 426 can store any data and code useful for performing processes as described herein. For example, storage 426 can store parcel data 451, which can include any parcel data, parcel information, address and destination data, sorting data, associations between parcels, destinations, chutes, pallets, carousels, and other elements, user inputs, device commands, or other data used for the monitoring and control of the parcel sorter system. Storage 426 can also store, as another example, executable code 452 that, when executed, causes processes as described herein to be performed.

I/O adapter 422 can be connected to parcel processing devices 428, as described herein, to which can include any hardware elements used to perform processes in accordance with the various embodiments described herein, including but not limited to sensors, conveyors, user input devices, display devices, indicators, conveyors, transporters, robots, parcel transport and management systems, etc.

Also connected to I/O bus 416 in the example shown is audio adapter 424, to which speakers (not shown) may be connected for playing sounds. Keyboard/mouse adapter 418 provides a connection for a pointing device (not shown), such as a mouse, trackball, trackpointer, etc.

Those of ordinary skill in the art will appreciate that the hardware depicted in FIG. 4 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 412 can be connected to a network 430 (not a part of data processing system 400), which can be any public or private data processing system network or combination of networks, as known to those of skill in the art, including the Internet. LAN/WAN/Wireless adapter 412 can also communicate with other devices or systems as described herein or as known for use in parcel processing or monitoring, and perform other data processing system or server processes described herein. Data processing system 400 can communicate over network 430 with one or more server systems 440, which are also not part of data processing system 400, but can be implemented, for example, as separate data processing systems 400. A server system 440 can be, for example, a central server or facility management system at a processing facility.

The exemplary data processing system 400 can also be used to implement an operator console or facility management system as described herein.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form. In particular, the features and operations of various examples described herein can be combined in any number of implementations.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

What is claimed is:

1. A method performed by a parcel sorter system, comprising:
receiving sorting information of a first parcel;
identifying a first destination pallet corresponding to the sorting information, wherein the first destination pallet is associated with a first pallet carousel and a first destination chute;
transporting the first parcel toward the first destination chute;
while transporting the parcel toward the first destination chute, operating the first pallet carousel to move the first destination pallet proximate to the first destination chute; and
delivering the first parcel at the first destination chute for placement on the first destination pallet.

2. The method of claim 1, further comprising moving the first parcel from the first destination chute to the first destination pallet.

3. The method of claim 2, wherein the parcel sorter system moves the first parcel from the first destination chute to the first destination pallet using a palletizing robot.

4. The method of claim 1, further comprising operating the first pallet carousel to move the first destination pallet into position to be removed from the first pallet carousel.

5. The method of claim 1, further comprising controlling a pallet transport and management system to remove and replace the first destination pallet.

6. The method of claim 5, wherein the pallet transport and management system shrink-wraps the first destination pallet.

7. The method of claim 1, wherein receiving sorting information of the first parcel includes using a reader to detect indicia on the first parcel and performing an optical character recognition process on the indicia.

8. The method of claim 1, wherein receiving sorting information of the first parcel includes using a reader to detect indicia on the first parcel and performing a barcode recognition process on the indicia.

9. The method of claim 1, wherein the first parcel is delivered to the first destination chute at the same time as or after the first destination pallet arrives proximate to the first destination chute.

10. The method of claim 1, further comprising determining that the first destination pallet is filled.

11. A parcel sorter system, comprising:
a control system;
a parcel sorter under control of the control system;
a plurality of destination chutes configured to receive parcels from the parcel sorter; and
a plurality of pallet carousels under control of the control system, each pallet carousel transporting a plurality of pallets,
wherein the control system is configured to:
receive sorting information of a first parcel;
identify a first destination pallet of the plurality of pallets corresponding to the sorting information, wherein the first destination pallet is associated with a first pallet carousel of the plurality or pallet carousels and a first destination chute of the plurality of destination chutes;
transport the first parcel toward the first destination chute on the parcel sorter;
while transporting the parcel toward the first destination chute, operate the first pallet carousel to move the first destination pallet proximate to the first destination chute; and
deliver the first parcel at the first destination chute for placement on the first destination pallet.

12. The parcel sorter system of claim 11, wherein the control system is further configured to move the first parcel from the first destination chute to the first destination pallet.

13. The parcel sorter system of claim 12, wherein the parcel sorter system moves the first parcel from the first destination chute to the first destination pallet using a palletizing robot.

14. The parcel sorter system of claim 11, wherein the control system is further configured to operate the first pallet carousel to move the first destination pallet into position to be removed from the first pallet carousel.

15. The parcel sorter system of claim 11, wherein the control system is further configured to control a pallet transport and management system to remove and replace the first destination pallet.

16. The parcel sorter system of claim 15, wherein the pallet transport and management system shrink-wraps the first destination pallet.

17. The parcel sorter system of claim 11, wherein receiving sorting information of the first parcel includes using a reader to detect indicia on the first parcel and performing an optical character recognition process on the indicia.

18. The parcel sorter system of claim 11, wherein receiving sorting information of the first parcel includes using a reader to detect indicia on the first parcel and performing a barcode recognition process on the indicia.

19. The parcel sorter system of claim 11, wherein the first parcel is delivered to the first destination chute at the same time as or after the first destination pallet arrives proximate to the first destination chute.

20. The parcel sorter system of claim 11, wherein the control system is further configured to determine that the first destination pallet is filled.
